(19) United States
(12) Patent Application Publication
(10) Pub. No.: US 2020/0019037 A1
(43) Pub. Date: Jan. 16, 2020

(54) MAPPING OPTICS FOR LIQUID CRYSTAL BEAMSTEERER

(71) Applicant: Analog Devices, Inc., Norwood, MA (US)

(72) Inventors: Michael Ziemkiewicz, Lakewood, CO (US); Scott Robert Davis, Denver, CO (US); Joseph D. Gamble, Parker, CO (US); Michael Howard Anderson, Lyons, CO (US); Benjamin Luey, Denver, CO (US)

(21) Appl. No.: 16/449,083

(22) Filed: Jun. 21, 2019

Related U.S. Application Data
(60) Provisional application No. 62/696,156, filed on Jul. 10, 2018.

(51) Int. Cl. G02F 1/29; G02F 1/21

(52) U.S. Cl. CPC G02F 1/292; G01S 17/89; G02F 1/216

(57) ABSTRACT

An electro-optical beamsteerer can be coupled with other optical structures. For example, such optical structures can be used to shape a beam being steered by the beamsteerer or shape a field-of-regard (FOR) addressable from the perspective of the beamsteerer. Optical elements placed at an output of the LCW can be used as a “spot mapper” to increase or decrease the field of view that can be scanned by a beam steered by the LCW, as an illustrative example, Lenses or other optical elements can also be used to correct distortion in the steered beam distribution across the field of view, such as to provide a “smile corrector.” In a similar manner, optical elements can be placed at an input to the beamsteerer, such as to provide a beam expander to change the size of the beam profile inside the beamsteerer device.

### FIELD OF THE DISCLOSURE

This document pertains generally, but not by way of limitation, to apparatus and techniques that can be used for optical detection, and more particularly to optical elements such as lenses that can be used in combination with an electro-optical beamsteerer.

### BACKGROUND

Optical systems can be used for a variety of applications such as sensing and detection. An optical detection system generally includes an optical transmitter and an optical receiver. The optical transmitter can include an illuminator module. For example, in a scanned transmit approach, the illuminator module can establish an output beam such as a spot or a line that can be mechanically or electro-optically steered to various locations (e.g., angular positions) to illuminate a field-of-regard (FOR). The optical receiver can capture light that is scattered by or reflected off one or more objects within a receiver field-of-view (FOV). An optical detection system, such as a system for providing light detection and ranging (LIDAR), can use various techniques for performing depth or distance estimation, such as to provide an estimate of a range to a target, such as a range from an optical transceiver assembly. Such detection techniques can include one or more “time-of-flight” determination techniques or other techniques. For example, a distance to one or more objects in a field of view can be estimated or tracked, such as by determining a time difference between a transmitted light pulse and a received light pulse. More sophisticated techniques can be used such as to track specific identified targets within a field of view of the optical detection system. In another example, time information can be encoded, and a LIDAR system can operate using a coherent or continuous wave approach.

### SUMMARY OF THE DISCLOSURE

Optical detection systems, such as laser range-finding or LIDAR systems, may operate by transmitting light towards a target region, using either a continuous wave or pulsed approach. The transmitted light can illuminate a portion of the target region. A portion of the transmitted light can be reflected or scattered by the illuminated portion of the target region and received by the LIDAR system. The LIDAR system can then determine a distance between the LIDAR system and the illuminated portion of the target region. In a pulsed-light approach, the LIDAR system can measure a time difference between transmitted and received light pulses, as an illustrative example. An optical transmitter in a LIDAR system can include a beam steering element to direct a beam of light to illuminate different regions in a field-of-regard (FOR) addressable by the beam steering element or “beamsteerer.” In one approach, an electro-optical device can be used as a beamsteerer. In an example, such as a “monostatic” configuration, the transmit beamsteerer can also operate to steer detected light (e.g., where the same beamsteerer may operate both as a steering element in the transmit signal chain and a steeling element in the detection signal chain). In such a monostatic example, the optical elements described herein may handle both output light (e.g., in the transmit sense) and input light (e.g., in the receive or detection sense).

An electro-optical beamsteerer, such as a liquid crystal waveguide (LCW) device, can be optically coupled with other optical structures. For example, such optical structures can be used to shape a beam being steered by the beamsteerer or shape a field-of-regard (FOR) addressable from the perspective of the beamsteerer. Optical elements placed at an output or exit of the beamsteerer can be used as a “spot mapper” to increase or decrease the field that can be scanned by the beamsteerer, as an illustrative example. Lenses or other optical elements can also be used to correct distortion in the steered beam distribution across the field-of-regard, such as to provide a “smile corrector.” In a similar manner, optical elements can be placed at an input to the beamsteerer, such as to provide a beam expander to change the size or shape of the beam profile inside the beamsteerer device.

The optical elements can include transmissive macroscale lenses (e.g., “macrolens”) structures, such as polymer or glass lenses, or other optical elements such as planar structures. In macroscale optics, an achievable f-number (represented as “f/#,” and corresponding to a focal length of the lens divided by a diameter of the entrance aperture) is generally limited by the nature of curvatures that can be achieved via molding or machining (e.g., grinding) techniques, along with the refractive indices of the materials available for these processes (such as glass or polymer materials). To overcome such challenges, planar structures can be used, and can include geometric phase lenses comprising a liquid crystal polymer, or planar structures incorporating a grating (e.g., a polarization grating), as illustrative examples.

In an example, an optical system can provide illumination of a field-of-regard for optical detection, the optical system comprising an el electro-optical beamsteerer, and an optical structure configured to adjust at least one of the field-of-regard or a shape of a beam provided by the electro-optical beamsteerer. In an example, the optical structure can include a planar optical structure, such as a polarization grating or geometric phase lens. In another example, the optical structure can include at least two lens structures, such as a converging lens and a diverging lens, In an example, the optical structure can include a prism, such as arranged as an anamorph. Combinations of such examples can also be used for the optical structure.

In an example, a technique such as a method can be used to generate illumination of a field-of-regard for optical detection. The technique can include receiving an input beam from an optical source, electro-optically steering the input beam using an electro-optical beamsteerer, and adjusting at least one of the field-of-regard or a shape of an output beam provided by the electro-optical beamsteerer using an optical structure. In an example, a beam distribution of the output beam provided by the electro-optical beamsteerer can be adjusted. In an example, a beam distribution of the input beam provided to the electro-optical beamsteerer can be adjusted. In an example, the technique can include establishing a distribution of spot sizes that vary across the field-of-regard, such as providing a smaller spot size (corresponding to enhanced resolution) at a center of the field-of-regard as compared to a periphery of the field of regard, using the optical structure.

Generally, the examples described in this document can be implemented in whole or in part within a module or assembly. A module or assembly can include a beamsteerer and related optical structures within a single package, as an illustrative example.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising a beamsteerer that can include a liquid crystal waveguide (LCW) structure, such as to provide beam steering in one or more of an in-plane direction or an out-of-plane direction.

FIG. 2 illustrates generally an example comprising a beamsteerer and an optical structure comprising lenses to at least one of adjust a field-of-regard or shape of a beam to illuminate the field-of-regard.

FIG. 3 illustrates generally an illustrative example comprising experimentally-obtained extents of a first field-of-regard corresponding to a beamsteerer, such as shown in FIG. 1, lacking an optical output structure as shown in FIG. 2, and a second field-of-regard corresponding to a field-of-regard addressable by the beamsteerer using an optical structure as shown in the illustrative example of FIG. 2.

FIG. 4 illustrates generally an example comprising a beamsteerer and an optical structure comprising a prism that can be placed in an output beam path, such as to one or more of change the beam width or the steering angular range after a beam exits the beamsteerer.

FIG. 5A and FIG. 5B illustrate generally examples comprising a beamsteerer and planar optical structures, such as can be used to at least one of reduce a width of a beam in at least one dimension, or increase a field-of-regard addressable by the beamsteerer.

FIG. 6 illustrates generally an example comprising a beamsteerer and an optical structure comprising planar optics to at least one of adjust a field-of-regard or shape of a beam to illuminate the field-of-regard.

FIG. 7A illustrates generally an example comprising a beamsteerer and an optical structure comprising a prism that can be placed in an output beam path, such as can be used to adjust a beam distribution at an output of the beamsteerer.

FIG. 7B and FIG. 7C illustrate respective examples comprising an uncorrected “smile” pattern of possible steering positions of a beam in FIG. 7B, and a corrected pattern such as can be achieved using the prism of FIG. 7A or another optical structure.

FIG. 8 illustrates generally an example comprising a prism (e.g., an anamorph), such as to receive a collimated cylindrical beam and to provide an elliptical beam to an input facet of a beamsteerer.

FIG. 9 illustrates generally a technique, such as a method, comprising receiving a beam from an optical source, electro-optically steering the beam, such as using a liquid crystal waveguide (LCW) structure, and adjusting at least one of a shape of the beam or a field-of-regard addressable by the electro-optical beamsteerer.

### DETAILED DESCRIPTION

As mentioned above, an optical detection system can include use of a scanned transmit scheme. For example, an illuminator for the optical system can include a light source such as a laser, and electro-optical beamsteerer. The electro-optical beamsteerer can be coupled with other optical structures. For example, such optical structures can be used to shape a beam being steered by the beamsteerer or shape a field-of-regard (FOR) addressable from the perspective of the beamsteerer. Optical elements placed at an output of the LCW can be used as a “spot mapper” to increase or decrease the field of view that can be scanned by a beam steered by the LCW, as an illustrative example. Lenses or other optical elements can also be used to correct distortion in the steered beam distribution across the field of view, such as to provide a “smile corrector.” In a similar manner, optical elements can be placed at an input to the beamsteerer, such as to provide a beam expander to change the size of the beam profile inside the beamsteerer device.

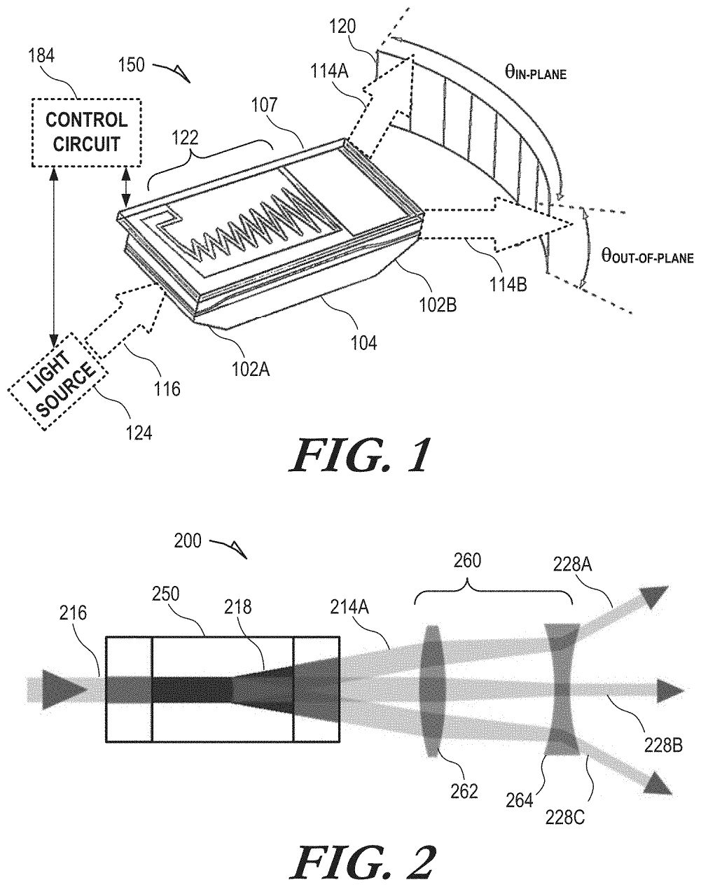

FIG. 1 illustrates generally an example comprising a beamsteerer 150 that can include a liquid crystal waveguide (LCW) structure. In a scanned transmit approach, use of a beamsteerer 150 can facilitate steering or scanning of the beam in one or two dimensions. For example, the beam can be scanned according to a raster pattern or other arbitrary pattern according to beam steering control signals provided to a beamsteerer 150 using an electrode pattern 122, such as to provide beam steering in one or more of an in-plane direction, spanning an angular range θ_{IN-PLANE}, or an out-of-plane direction spanning an angular range θ_{OUT-OF-PLANE}, such as to address a two-dimensional angular space 120. Such control signals can be provided by a control circuit 184 that is communicatively coupled to the beamsteerer 150. The control circuit 184 can be communicatively coupled to the light source 124, such as to trigger or otherwise control emission of the beam 116 by the light source.

The beamsteerer 150 can include an input facet 102A for incoupling light 116 into a semiconductor slab 104, and an output facet 102B for outcoupling light 114A or 114B in a direction established by the beamsteerer 150. The slab 104 can include or can overlay a planar LCW cell 107, which, in turn can rest upon an underlying glass or other mounting block such as can be located on the opposing side of the LCW cell 107. The planar LCW cell 107 can include a subcladding and a generally planar Liquid Crystal (LC) core. The subcladding thins in locations underlying the incoupling and outcoupling zones of the slab 104, such as to allow light passage through the subcladding in such zones, The inner surfaces of the slab 104 and the cell 107 or other supporting structure can be coated or implanted with one or more layers, such as for establishing the optical and electronic conditions suitable for beam steering a light beam in a particular specified range of wavelengths.

In the example of FIG. 1, the facets 102A and 102B are obliquely angled with respect to a longitudinal direction of the planar LCW cell 107, such as with a continuous planar facets 102A and 102B sized large enough to accommodate an entire diameter or beamsize normal component of the incoupled light beam 116 or outcoupled light beam 114A or 114B. As shown in the example of FIG. 1, two continuous planar facets 102A and 102B can be cut into the slab 104 having a facet angle near Brewster's angle for air (or other light entrance or exit adjacent medium) and for the material of the slab 104. These facets 102A and 102B can serve as high efficiency light entrance and exit windows at the substrate-air interface. When “Ulrich coupling” is used to transfer light from the slab 104 to the LC waveguide core, the facets 102A and 102B are used because the LCW physics need total internal reflection (TIR) to occur when the laser beam strikes the substrate-LC interface from the slab 104 side in the region of the LC waveguide core. Since the index of refraction of air is lower than the index of refraction of any LC layer, light must also undergo TIR at a parallel substrate-air interface. Therefore, light can only properly enter or exit the slab 104 by cutting the facets 102A and 102B to change the angle at which the laser strikes the substrate-air interface.

The example of FIG. 1 is illustrative, and other approaches can be used, such as involving use of a beamsteerer having a grating incoupling or outcoupling structure, without requiring use of a faceted slab 104. Illustrative (but non-limiting) examples of waveguide structures that can be used to provide the beamsteerer 150 can be found in (1) U.S. Pat. No. 10,133,083; (2) U.S. Pat. No. 10,120,261; (3) U.S. Pat. Nos. 9,366,938, 9,885,892, 9,829,766, and 9,880,443; (4) U.S. Pat. Nos. 8,311,372 and 8,380,025; (5) U.S. Pat. No. 8,860,897; (6) U.S. Pat. No. 8,463,080; and (7) U.S. Pat. No. 7,570,320, all of which are incorporated herein by reference in their entireties, including for their description of LCWs and uses such as for beam steering of light, including in-plane and out-of-plane beam steering.

In a beamsteerer 150 as shown in the illustration of FIG. 1, shaped electrodes in the pattern 122 can be used to change the optical properties of a liquid crystal waveguide layer in order to deflect the beam. Other patterns can be used, such as to provide discrete angular control increments or continuously-variable control over a steering angle, or a combination of different control schemes such as respective patterns to establish relatively more coarse and relatively more fine angular resolution for steering control. Steering efficiency and power handling can both be improved by increasing the width of the input beam 116, such as corresponding to an output from a light source 124 such as a semiconductor laser light source or a fiber laser. As shown in other examples herein, the beamsteerer 150 can be optically coupled to optics at its output, such as to provide a “spot mapper” optical structure that can convert the beam into a form that is appropriate for propagating light into the far field.

FIG. 2 illustrates generally an example 200 comprising a beamsteerer 250 and an optical structure 260 comprising lenses to at least one of adjust a field-of-regard or shape of a beam to illuminate the field-of-regard. As an illustrative example, a laser beam 216 provided to the beamsteerer 250 can be at least approximately diffraction-limited, collimated at the beamsteerer 250 input, and can be characterized by a Rayleigh length that is long compared to a length of the beamsteerer 250 device along a longitudinal axis (e.g., along the horizontal axis of the page along the direction of beam propagation). In this example, a smaller laser spot size at the beamsteerer exit (e.g., corresponding to an output beam 214 near an exit of the beamsteerer 250) will result in a larger spot size far away from the beamsteerer 250 (e.g., in the far field). An output optic (e.g., optical structure 260) can provide a “spot mapper” that can be used to generate the desired laser spot geometry in the far field while still allowing for some degree of optimization of the laser spot 218 while it is propagating within the beamsteerer 250. A far-field spot size is generally related to a range of steering angles that the system can address (e.g., a field-of-regard (FOR)), such as corresponding to an angular range accessible by output beams 228A, 228B, and 228C, corresponding to different steering angles.

In the example 200 of FIG. 2, the three beams of light 228A, 228B, 2280. are shown being steered in three different directions, with the spot mapper optical structure 260 providing an enhanced (e.g., widened) field-of-regard as compared to the angular range of the beams (e.g., beam 214A) at the exit of the beamsteerer 250. The example 250 of FIG. 2 is an illustrative example, and shows rays projected in different directions in a single plane. In general, spot mapper optics can be used to steer and shape light in two dimensions. The lens structures can be spherical, cylindrical, or astigmatic depending on the nature of the input and output beam distributions. In this context, the input beam distribution to the spot mapper would correspond to an exit beam 214A distribution of the LCW beamsteerer, and the output beam distribution of the spot mapper optics would correspond to the far-field beam distribution, including beams 228A, 228B, or 228C).

The spot distribution in the far-field need not be uniform. For example, an “irregular” spot distribution can be achieved. In an example, relatively smaller far-field spots can be provided in proximity to the optical axis (e.g., a central axis extending in a longitudinal direction), and the spot size can be relatively larger in a direction extending laterally or vertically away from the axis. In this manner, a foveated scanning scheme can be used, such as to provide enhanced resolution in a central region of the field-of-regard. In the example 200 shown in FIG. 2, the spot mapper optical structure reduces beam diameter while increasing steering angular range compared to the set of beams that are present without the optical structure 260.

The configuration of FIG, 2 can be similar to a Galilean telescope comprising a converging lens 262 and a diverging lens 264. As an illustrative example, the lenses 262 and 265 can have a diameter of 25 millimeters (mm) and a separation of 25 mm from center-to-center, with the converging lens 262 having a focal length of f=+50 mm, and the diverging lens 264 having a focal length of f=25 mm. A ratio between the magnitudes of the focal lengths provides a near-field beam size reduction of a factor of 2 (“2×”).

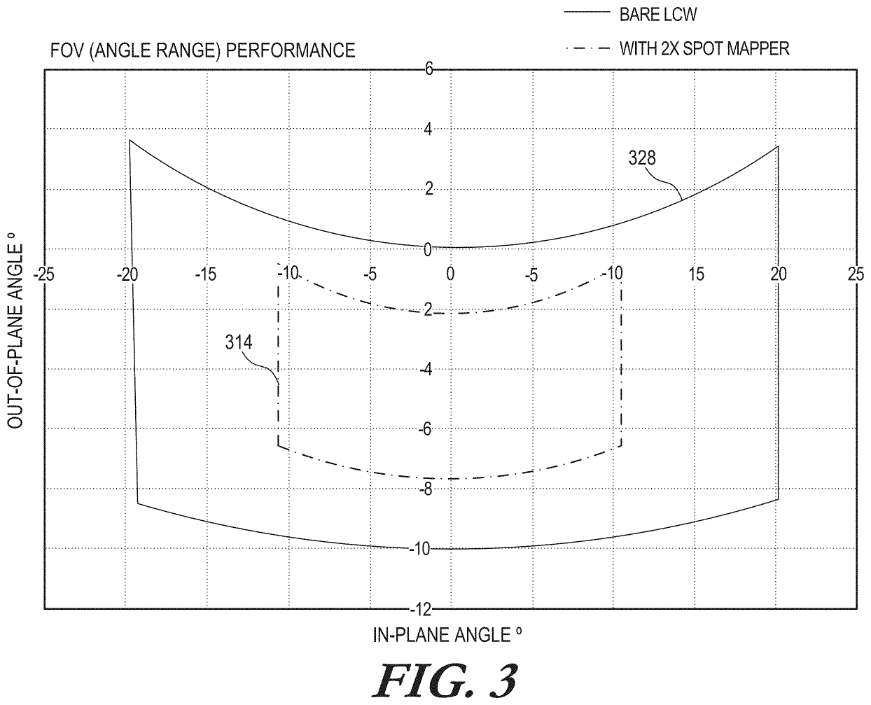

Along with a reduction in beam size, the configuration shown in FIG. 2 also increases the scanned angular field-of-regard by about a factor of two, and such a configuration will output collimated light if collimated light is incident on it. The configuration illustrated in FIG. 2 has been experimentally demonstrated, and such results—shown below in FIG. 3—indicate that the configuration shown in FIG. 2 may be able to provide beam compression with minimal distortion (widening) of the far-field beam. The configuration shown in FIG. 2 is illustrative, but other optical configurations can be used, such as more complex configurations. For example, optical structures 260 can be arranged to transfer a specified set of beams exiting the beamsteerer 250 into a desired set of output beams in the far field, such as using astigmatic optics (e.g., cylindrical or toric lenses), a larger count of lenses (e.g., greater than the two lenses shown in FIG. 2), and lenses having different diameters. The use of transmissive optics is illustrative, and the configurations shown and described herein may be implemented using reflective optics (e.g., curved mirrors) instead of refractive transmissive lenses. FIG. 3 illustrates generally an illustrative example comprising experimentally-obtained extents of a first field-of-regard 314 corresponding to a beamsteerer 150, such as shown in FIG. 1, lacking an optical output structure 260 as shown in FIG. 2, and a second field-of-regard 328 corresponding to a field-of-regard addressable by the beamsteerer 250 using an optical structure 260 as shown in the illustrative example 200 of FIG. 2.

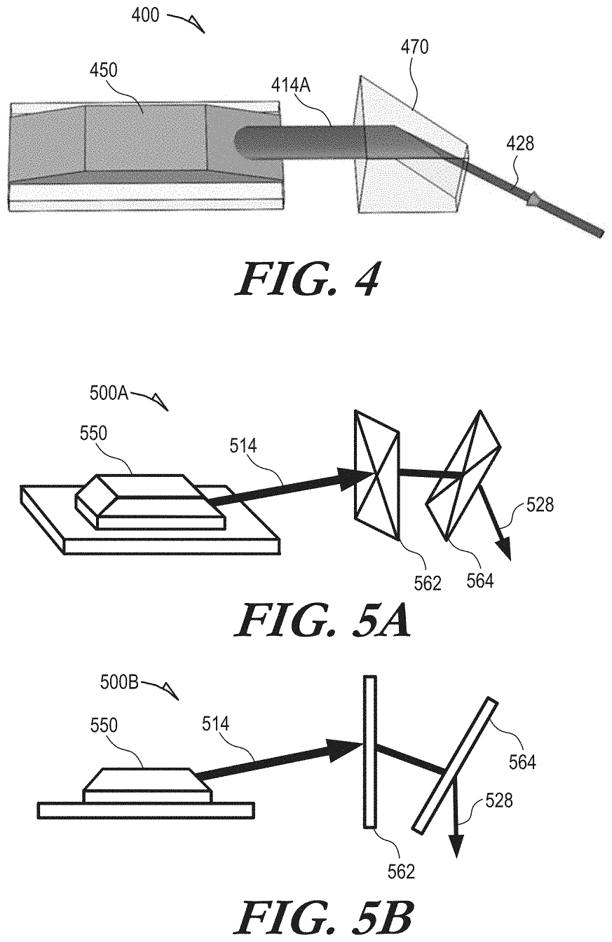

FIG. 4 illustrates generally an example 400 comprising a beamsteerer 450 and an optical structure comprising a prism 470 (e.g., an anamorph) that can be placed in an output beam 414A path, such as to one or more of change the beam width or the steering angular range after a beam exits the beamsteerer 450, such as to provide an output beam 428. The technique shown in FIG. 4 can be used instead of the optical structure 260 mentioned above in relation to FIG. 2 or in addition to such a structure 260. in the illustrative example 400 of FIG. 4, the output beam 428 size and scan range are both adjusted by a prism.

When the beam 414A refracts at prism 470 interfaces, its size can be decreased or increased depending on geometry of the angle of incidence and the refractive index of the prism 470 material. As in the case of the optical lens system in FIG. 2, a decrease in beam 414A width generally results in an increase in field-of-regard and vice-versa. Note that in the example 400 of FIG. 4, each prism 470 interface reduces or increases beam size in one dimension only. Accordingly, a combination of two or more prisms could be used to provide reshaping of the beam 414A or adjustment of the field-of-regard in multiple dimensions.

Generally, the examples above of FIG. 2 and FIG. 4 mention refractive optical structures, but other types of optical structures can be used. For example, the spot mapping optical structure can include one or more grating structures. FIG. 5A and FIG. 5B illustrate generally examples 500A and 500B comprising a beamsteerer 550 and planar optical structures 562 and 564, such as can be used to at least one of reduce a width of a beam in at least one dimension, or increase a field-of-regard addressable by the beamsteerer 550.

Generally, grating structures can include reflective or transmissive gratings. As an example, polarization gratings (PGs) can diffract light into a specific order with high efficiency (e.g., with low or minimal loss associated with coupling of light into unwanted orders). The planar optical structures 562 and 564 can include polarization gratings (“PG structures”) or diffractive waveplates, as illustrative examples. Generally, PG structures are thin (e.g., on the order of micrometers) and can provide high transmissivity, so such structures can be efficiently stacked in a series of two or more for additional beam shaping stages. Other planar structure 562 and 564 can be used, such as geometric phase lenses (GPLs) to provide optical structures including lens behavior, prism behavior, or mirror behavior, and such planar structures can be used in relation to the examples 500A and 500B of FIG. 5A and FIG. 5B, or other examples described in this document (such as in place of transmissive macrolens structures).

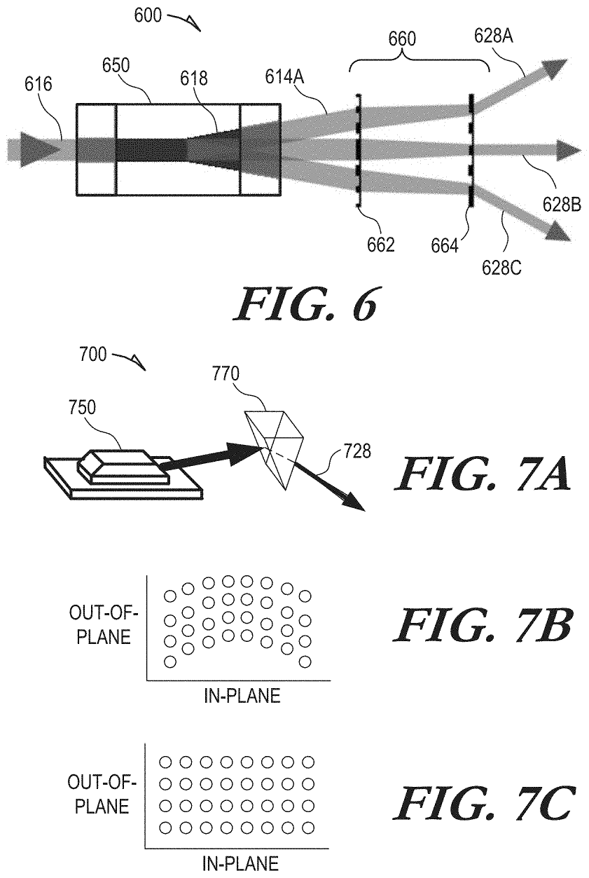

For example, FIG. 6 illustrates generally an example 600 comprising a beamsteerer 650 and an optical structure 660 comprising planar optics 662 and 664 to at least one of adjust a field-of-regard or shape of a beam 614A to illuminate the field-of-regard. As in the example 200 of FIG. 2, a beam 616 can be provided at an input to the beamsteerer 650, and within the beamsteerer 650, light 618 can be steered to provide an output beam (e.g., a beam 614A). Planar optical structures, such as incorporating liquid crystal polymer (LCP) materials can use geometric phase (rather than optical path length), so that incident light 614A having a certain polarization will assume a specified phase profile upon transiting the LCP structures (e.g., traversing planar structures 662 and 664), to provide output beams 628A, 628B, or 628C having one or more of an adjusted beam profile (e.g., beam shape) or enhanced addressable angular range. Use of LCP structures for the optical structure 660 can avoid spherical aberration. Planarity of LCP lens structures can also simplify manufacturing, such as facilitating co-integration with other optical structures. Such simplification can also ease challenges relating to alignment. LCP optical structures may be fabricated to provide lower f/# than might be readily achieved with other types of lenses.

FIG. 7A illustrates generally an example 700 comprising a beamsteerer 750 and an optical structure comprising a prism 770 that can be placed in an output beam path, such as can be used to adjust a beam 728 distribution at an output of the beamsteerer 750, and FIG. 7B and FIG. 7C illustrate respective examples comprising an uncorrected “smile” pattern of possible steering positions of a beam in FIG. 7B, and a corrected pattern such as can be achieved using the prism of FIG. 7A or another optical structure. In the example 700 of FIG. 7A, light exiting the beamsteerer 750 device is made to travel through a prism 770, similar to the example 400 shown in FIG. 4. In the example of FIG. 7A, instead of or in addition to applying a constant adjustment or correction to the shape of the output beam, the prism 770 can be arranged to provide correction to distortion in the total field-of-regard (FOR)—the range of positions in angular space that are addressable from the perspective of the beamsteerer 750. As an illustrative example, such distortion, when uncorrected, may form a “smile” pattern as shown in FIG. 7B, and can be caused by variations in 1) refracted angles such as when beams strike the output facet of the beamsteerer 750 at compound angles that are not perpendicular to any of the principal directions of the device. Use of a prism 770 as shown in FIG. 7A can greatly improve the even-ness of the coverage of the field of view without requiring adjustment of an output beam size. For example, a corrected pattern showing more even coverage is shown illustratively in FIG. 7C. FIG. 7A illustrates a single prism 770, but such correction can be implemented using multiple prisms, lens systems, or grating structures, similar to the configurations mentioned in relation to other examples herein.

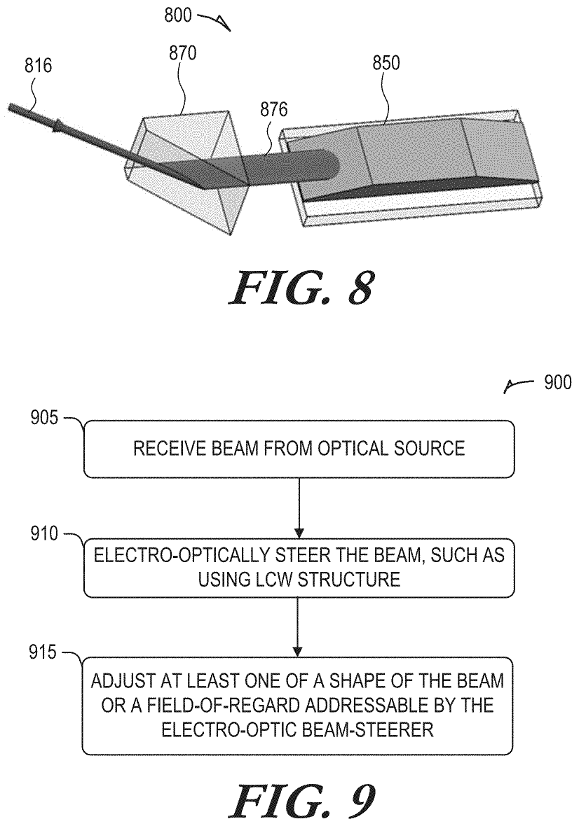

FIG. 8 illustrates generally an example 800 comprising a prism 870 (e.g., an anamorph), such as to receive a collimated cylindrical beam 816 and to provide an elliptical beam 876 to an input facet of a beamsteerer 850. Other examples in this document generally concern one or more of beam shaping or adjusting a field-of-regard (FOR) using optics at the exit of the beamsteerer 850. Various optical structures can also be used for beam forming at an input to the beamsteerer 850. For example, FIG. 8 shows an example 800 where the prism 870 is positioned to adjust (e.g., widen) an input beam 816 in one dimension before it enters the beamsteerer 850. The configuration of FIG. 8 can provide benefit because it is generally easier to output a collimated circular beam from a light source (e.g., a laser system), but an elliptical beam shape may be desired within the beamsteerer 850, as an illustrative example.

Generally, for LCW devices used as the beamsteerer 850, a desired beam height and geometry may be determined by the method used to couple light into the waveguide core. For example, a smaller beam height generally allows for a shorter tapered region (e.g., faceted region) of the waveguide core. Such a shorter tapered region facilitates manufacturing of smaller, lower-cost devices. A width of the beam 876 need not be constrained in this manner. For example, a wider beam can provide improved power handling characteristics (e.g., by spreading the beam energy spatially within the waveguide core), which in turn allows for a higher power beam and therefore longer range operation, such as in a LIDAR application. Additionally, wider beams can be steered over more spots in the far field, allowing for higher resolution in LIDAR imaging or targeting.

FIG. 9 illustrates generally a technique 900, such as a method, comprising receiving a beam from an optical source at 905, electro-optically steering the beam at 910, such as using a liquid crystal waveguide (LEW) structure, and adjusting at least one of a shape of the beam or a field-of-regard addressable by the electro-optical beamsteerer 915.

Each of the non-limiting aspects in this document can stand on its own, or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed. Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. An optical system for providing illumination of a field-of-regard for optical detection, the optical system comprising:
an electro-optical beamsteerer; and
an optical structure configured to adjust at least one of the field-of-regard or a shape of a beam provided by the electro-optical beamsteerer.

2. The optical system of claim 1, wherein the optical structure comprises at least one planar optical structure.

3. The optical system of claim 2, wherein the planar optical structure comprises at least one of a polarization grating (PG) or a geometric phase lens (GPL).

4. The optical system of claim 1, wherein the optical structure comprises at least two lens structures, including converging lens and a diverging lens amongst the at least two lens structures.

5. The optical system of claim 1, wherein the optical structure comprises a prism optically coupled to an output of the electro-optical beamsteerer.

6. The optical system of claim 1, wherein the optical structure comprises a first anamorph to adjust a beam distribution of the beam provided by the electro-optical beamsteerer.

7. The optical system of claim 6, comprising an input optical structure to adjust a beam distribution of an input beam provided to the electro-optical beamsteerer.

8. The optical system of claim 7, wherein the input optical structure comprises a second anamorph.

9. The optical system of claim 8, wherein the beam distribution of the beam provided to the electro-optical beamsteerer comprises an elliptical beam distribution.

10. The optical system of claim 1, wherein the electro-optical beamsteerer comprises a liquid crystal waveguide (LCW) structure.

11. The optical system of claim 1, comprising an optical source optically coupled to the electro-optical beam steerer, the optical source and the electro-optical beam steerer communicatively coupled to a control circuit to provide steering of light from the optical source to a region encompassing a target.

12. The optical system of claim 1, wherein the optical structure is configured to enhance the field-of-regard addressable by the electro-optical beamsteerer.

13. The optical system of claim 1, wherein the optical structure is configured to decrease a size of a spot formed by the beam at a specified range as compared to a size of the spot in the absence of the optical structure.

14. The optical system of claim 1, wherein the optical structure is configured to decrease a size of a spot formed by the beam at a specified range; and
wherein a distribution of spot sizes varies across the field-of-regard, providing a smaller spot size at a center of the field-of-regard as compared to a periphery of the field of regard.

15. A method for generating illumination of a field-of-regard for optical detection, the method comprising:
receiving an input beam from an optical source;
electro-optically steering the input beam using an electro-optical beamsteerer; and
adjusting at least one of the field-of-regard or a shape of an output beam provided by the electro-optical beamsteerer using an optical structure.

16. The method of claim 15, comprising adjusting a beam distribution of the output beam provided by the electro-optical beamsteerer.

17. The method of claim 15, comprising adjusting a beam distribution of the input beam provided to the electro-optical beamsteerer.

18. The method of claim 15, comprising establishing a distribution of spot sizes that vary across the field-of-regard, providing a smaller spot size at a center of the field-of-regard as compared to a periphery of the field of regard, using the optical structure.

19. An optical system for providing illumination of a field-of-regard for optical detection, the optical system comprising:
a means for steering an input beam provided by an optical source;
a means for adjusting at least one of the field-of-regard or a shape of an output beam provided by the means for steering the beam.

20. The optical system of claim 19, wherein the means for adjusting at least of the field-of-regard or the shape of the beam comprises a means for adjusting a beam distribution of the output beam provided by the electro-optical beamsteerer.
